(19) United States
(12) Patent Application Publication
(10) Pub. No.: US 2008/0168122 A1
(43) Pub. Date: Jul. 10, 2008

(54) PUBLISH/SUBSCRIBE SYSTEM

(76) Inventors: Benjamin Joseph Fletcher, Huddersfield (GB); Martin J. Gale, Eastleigh (GB); Andrew David Reynolds, Southampton (GB)

Correspondence Address: IBM CORPORATION, 3039 CORNWALLIS RD., DEPT. T81 / B503, PO BOX 12195, REASEARCH TRIANGLE PARK, NC, 27709, US

(21) Appl. No.: 11/970,815

(22) Filed: Jan. 8, 2008

(30) Foreign Application Priority Data
Jan. 10, 2007 (EP) 07100333.9

(51) Int. Cl. G06F 15/16; G06F 17/30

(52) U.S. Cl. 709/201; 707/100; 707/E17.044

(57) ABSTRACT

In a publish/subscribe system, messages may be received from one or more publishers and forwarded to one or more subscribers who have registered an interest in receiving messages on topics to which the messages pertain. An improved retention mechanism is implemented by identifying a message is one for which retention may be applicable. Once the message has been identified, an algorithm is executed to establish a retention policy for the message. The algorithm may be based on the message contents or upon the state of the publish/subscribe system or the history of publish/subscribe transactions relating to the topic to which the message pertains.

### BACKGROUND OF THE INVENTION

This invention relates to a publish/subscribe system and in particular to a flexible message retention mechanism for a publish/subscribe broker.

Conventional publish/subscribe models used fixed, pre-named topics to decouple publishers from subscribers (for example, a topic may be specified as “stock/IBM”). Publishers and subscribers do not need to communicate with each other as each has a connection to an intermediate message broker or message broker network. Publishers include topic information within their publications, and subscribers specify their topics of interest when subscribing to the message broker. The broker matches publications received from publishers to subscriptions established by subscribers and then forwards the publications to the appropriate set of subscribers. From time to time in this description, the term “message” may be used interchangeably with the term “publication”.

Normally, a publication is deleted after a copy has been delivered to all currently matching subscribers. However, in some situations publications are retained by the broker maintaining a copy of a message even after it has been delivered to the entire set of currently matching subscribers. The retained publication is typically the last publication that was received by the publish/subscribe broker on a topic. A retained publication allows a new subscriber to receive the latest publication on a topic when the subscription becomes active, rather than have to wait for the next publication on the topic.

A retained message can become out-of-date or otherwise incorrect. For example, a message concerning the time at which an event will take place may no longer be useful, and indeed may even be confusing, to a subscriber once the event has already taken place. Thus, a mechanism for removing such retained publications is required.

One known deletion mechanism comprises specifying an expiry time in the message, which tells the broker that the publication is to expire at a particular time or after a certain amount of time has elapsed. However, this mechanism is inflexible as the expiry time must be preset when the message is sent. Another known deletion mechanism comprises manually deleting the message once it becomes known that the message is out of date. However, the inherent delay and user effort required for manual deletion operations makes this deletion mechanism an unattractive option.

As noted above, a retained publication may be the last message published on a topic, which is held by the broker so that new subscribers to the topic get the most recent message on a topic when they first subscribe to that topic. This is very convenient for, say, information feeds. However once a message is retained, it can remain in data storage indefinitely and effectively become akin to a memory leak as it will continually consume memory resources.

The known solution of setting an expiry time is inflexible, and results in some publications been retained for longer than required while other publications are deleted too soon.

### BRIEF SUMMARY OF THE INVENTION

The present invention may be implemented as a method of operating a publish/subscribe system. When a message is received from a publisher, a determination is made whether the message should be retained. A retention policy is established for the received message as a response to a determination that the message should be retained.

The present invention may also be implemented as a computer program product for operating a publish/subscribe system. The computer program product includes a computer usable media embodying computer usable program code configured to receive a message from a publisher, determine whether the message should be retained and, in response to a determination the message should be retained, to establish a retention policy for the received message.

The invention may also be implemented as a message broker for a publish/subscribe system. The message broker includes means for receiving a message from a publisher and for determining whether the message should be retained. The broker further includes means, responsive to a determination of the message should be retained, for establishing a retention policy for the received message.

### BRIEF DESCRIPTION OF THE SEVERAL VIEWS OF THE DRAWINGS

FIG. 1 is a schematic diagram of a publish/subscribe system,

FIG. 2 is a further schematic diagram of the system of FIG. 1, and

FIG. 3 is a flow diagram of a method of operating the publish/subscribe system.

FIG. 4 is a functional block diagram of major components of a general purpose computer that could be used to implement an embodiment of the present invention.

### DETAILED DESCRIPTION OF THE INVENTION

As will be appreciated by one skilled in the art, the present invention may be embodied as a method, system, or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product on a computer-usable storage medium having computer-usable program code embodied in the medium.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, RF, etc.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

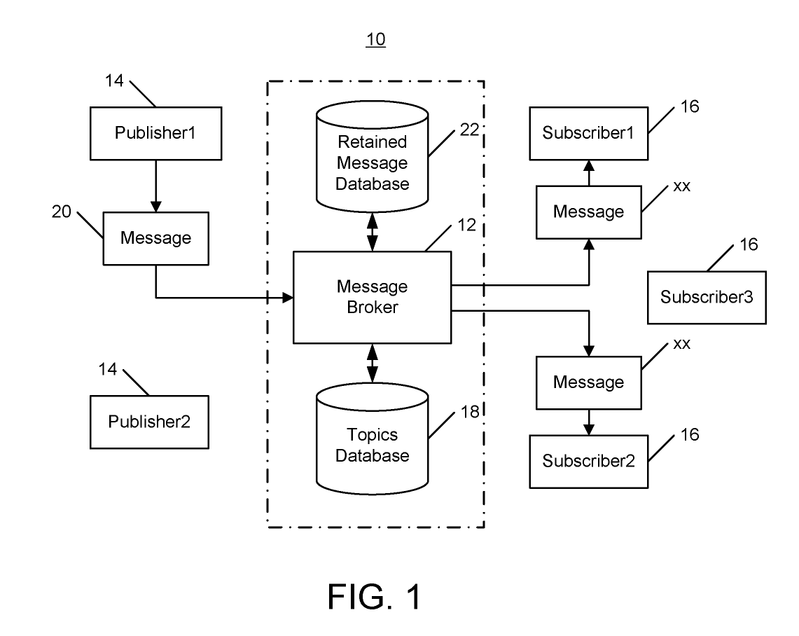

FIG. 1 illustrates a publish/subscribe system 10 which includes a message broker 12. The role of the message broker 12 is to mediate between publishers 14 and subscribers 16. The system 10 also includes a topics database 18, which maintains details of topics and details of the subscribers that have subscribed to particular topics. The system 10 may use a simple command interface by which subscribers 16 can subscribe and unsubscribe from each of the topics maintained by the topics database 18 and which supports the creation and deletion of the topics themselves.

When a message 20 from a publisher 14 is received by the message broker 12, the message 20 is transmitted by the message broker 12 to each of the subscribers 16 that is identified by the topics database 18 as a subscriber to that topic. The topic associated with the message 20 must be determined by the message broker 12 as part of this process. The topic may be explicitly stated in the publish message 20 received by the message broker 12 or may be implicit within the message 20, in which case the message broker 12 must ascertain the topic from the content of the message 20. In a simple format, the message 20 will be of the form “TOPIC1:DATA”, and the message broker 12 will transmit the “DATA” component of the message 20 to each of the subscribers 16 to the topic “TOPIC1”.

In the example of FIG. 1, the message 20 is assumed to relate to the topic “TOPIC1” and to be transmitted to two subscribers S1 and S2, each of whom is defined in the database 18 as having subscribed to that topic. Whenever a message 20 that relates to “TOPIC1” is received by the message broker 12, then the broker 12 will send it to the current set of subscribers for “TOPIC1”, as defined by the topic database 18, without regard to which publisher 14 sends that message 20.

The publish/subscribe system 10 also includes a retained message database 22. In general, once the message broker 12 has received the message 20 from the publisher 14 and has transmitted the message 20 to the appropriate subscribers 16, the message 20 is discarded since storing all received messages would rapidly create a huge data storage requirement given that a conventional publish/subscribe system typically maintains a very large number of topics and messages can arrive almost continually on each topic. However. a subset of received messages can be stored in the retained message database 22.

Several different configurations of the database 22 are possible. The last received message on each topic can be retained, for example. This allows new subscribers to a topic to receive the last published message on that specific topic when they first subscribe to the topic. It is also possible for messages 20 from the publishers 14 to specify that they should be retained, by setting a flag within the message. This allows publishers to designate that a specific message is important and should be retained, usually for the purpose of providing that retained message to a new subscriber 16. The retained message database 22 can be configured so that no more than one message is ever stored for each topic, with any previously retained message being deleted when a new message arrives.

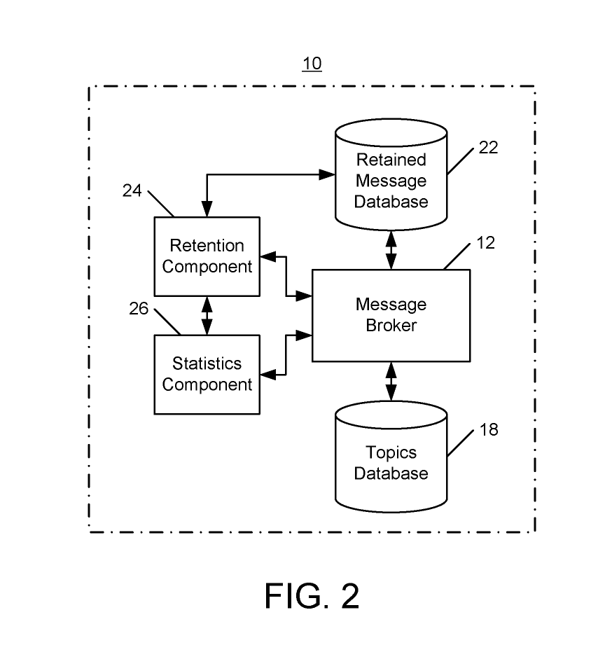

FIG. 2 shows the publish/subscribe system 10 of FIG. 1 in more detail. In addition to the message broker 12, which receive messages from publishers and transmits the messages to one or more subscribers, the system 10 includes a retention component 24 and a statistics component 26. These two components 24 and 26 communicate with the message broker 12, and the retention component is connected to the retained message database 22.

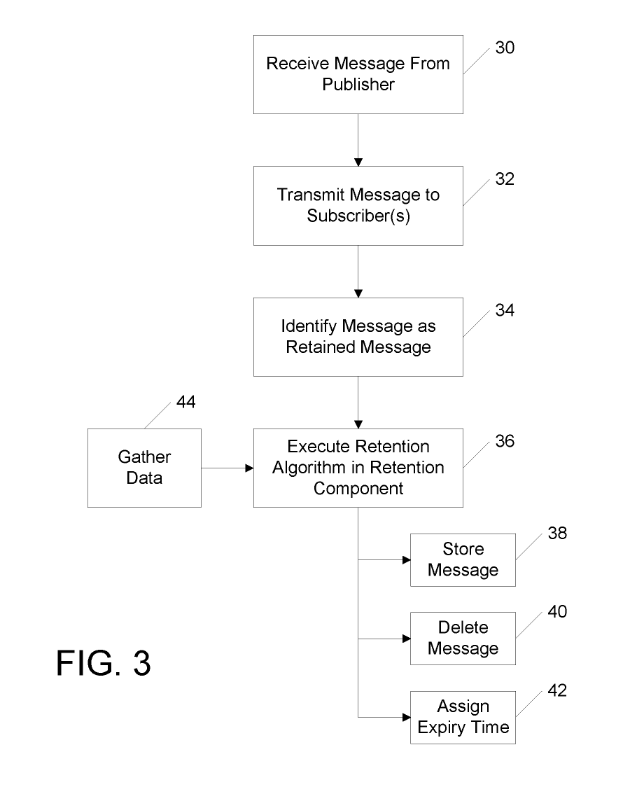

Once a message has been identified as a potential retained message (for example, by identifying a ‘retain’ flag within the message or by identifying a topic within the message for which the broker has a policy of ‘retain latest publication’), the retention component 24 executes an algorithm in relation to that message, and based on the results of the algorithm execution, acts to store the message, to delete one or more messages, or to assign one or more messages a future expiry time. This is explained in more detail below, with reference to FIG. 3. In effect, the retention component 24 manages the storage of retained messages in the database 22. The retention component 24 operates every time a message is identified as appearing to require retention, usually during receipt of the message.

The statistics component 26 gathers data relating to the operation of the publish/subscribe system 10, providing the gathered data as an input to an algorithm being executed by the retention component 24. Again, this is explained in more detail below, with reference to FIG. 3. The statistics component 26 gathers data relating to such things as subscriber information (when was the last active subscription on a topic, for example) and/or the number of received messages (on a per topic basis). The component 26 can store the gathered data and supply that data to the retention component 24, as the data is needed by the retention component 24.

While the retention component 24 and the statistics component 26 are operating, the message broker 12 functions without any adaptation required. The message broker 12 will handle incoming messages as normal, receiving and transmitting messages without interference from the components 24 and 26. The retention component 24 manages the storage of the retained messages and the statistics component 26 monitors and records statistical data relating to the performance of the system 10.

FIG. 3 summarizes the method of operating the publish/subscribe system 10. The first step 30 is the conventional receiving of the message 20 from a publisher 14, followed by the next step 32 of transmitting the message 20 to one or more subscribers 16, which is carried out by the message broker 12 on the per topic basis.

The next step 34 is the step of identifying the message 20 as a message that appears to require retention. The message broker 12 may identify the message 20 as one that should be stored based on the topic to which it relates. The message 20 may itself carry a flag requesting retention, or the message broker 12 may execute its own decision making process, such as a “store last message” policy for certain topics. Once the message 20 is identified as a retained message, then the retention component 24 is called into action to process the retention policy of the publish/subscribe system 10. Multiple policies may be used by the retention component 24. Each policy used is embedded in the algorithm run by the component 24.

The retention component 24, at step 36, executes the algorithm for the received message 20 and, according to the results of the algorithm execution, either stores the message (step 38), deletes one or more messages (step 40), or assigns a future deletion time to one or more messages (step 42). The retention component 24 has access to one or more policies that define the handling of the retained messages. These can be managed by an administrator. A very simple policy will be to delete the received message if the message exceeds a certain size.

The statistics component 26 gathers data (step 44) about the operation of the system 10. The gathered data can be used by the retention component 24 when executing an algorithm according to the various policies. For example, the statistics component 26 can be configured to monitor the new subscribers 16 on a specific topic (or on all topics). This information can be provided to the retention component 24, which may implement a policy that a retained message will be deleted if there have not been any new subscribers 16 to the topic of the message in the last two hours. In this case the algorithm would output a result requiring that the specific message 20 be deleted rather than retained.

Other factors such as message throughput per topic and number of subscribers can be monitored by the statistics component 26 and used by the retention component 24. For example, if a topic has a relatively high message throughput, such as a new message every two seconds, then the retention component 24 can decide not to retain any messages for that topic, as any retained message would be superseded very quickly.

The retention component 24 can also decide to retain the message, while assigning a future deletion time to the message. For example, the retention component 24 may operate to retain a particular message for a particular time period t following its receipt. When the time t has elapsed, the retention component 24 will delete that message.

One possible result of execution of an algorithm may be to delete or assign future deletion times to messages other than the actual received message. For example, a retention policy may require that no more than a specific number of messages be retained on a particular topic or that only a limited amount of memory space be made available for retaining messages on a particular topic. A hierarchy of retained messages on a particular topic can be established that leads to the replacement of one or more previously stored messages by any newly retained message.

An input to the algorithm can be provided by content in the message received. For example, the retention component 24 may look for a specific word or phrase in a received message that indicates a change in status of a topic. For example, if a topic relates to an airline flight, then the appearance of the word “LANDED” in a message for that topic, could be used to set a flag that no more messages are to be saved on the topic once two hours have elapsed, on the basis that after this time has passed, there is unlikely to be anybody still interested in the topic.

The retention component 24 can be implemented as an addendum to the pub/sub matching engine. In addition, the statistical component 26 can be added fairly readily to the internal components (pub/sub engine, communication components) to derive meta-data about topics, connections and so on.

A simple embodiment of the statistical component 26 could be a hash-table containing well-known keys to the data, with updates to the statistic next to each key, and with the retention component 24 able to take a snapshot when applying policies. A simple example of a policy descriptor can be shown as an XML document for consumption by the retention component 24:

```
<retention-policy topic=“arrivals/#”>
  <action type=”purge”>
    <constraint>
      <time-inactive>2</time-inactive>
        <payload-match>LANDED</payload-match>
    </constraint>
  </action>
</retention-policy>
```

More complex algorithms are possible such as one where a combination of topics and/or sources influence the retention of a message using Bayesian networks. Such algorithms may implemented similarly to the above using existing standards with pub/sub retain messages as nodes and lines coming in from other nodes and sources like usage, popularity, degree of importance, etc., with a different weighting for each line.

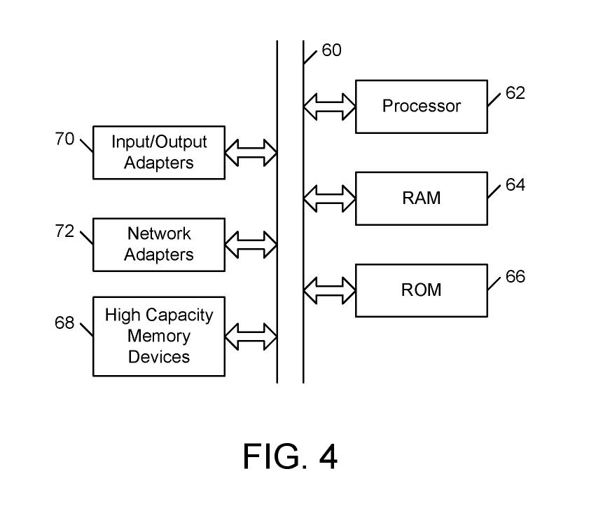

FIG. 4 is a block diagram of a hardware infrastructure for a general-purpose computer device that could, when programmed properly, be used to implement the present invention. The infrastructure includes a system bus 60 that carries information and data among a plurality of hardware subsystems including a processor 62 used to execute program instructions received from computer applications running on the hardware. The infrastructure also includes random access memory (RAM) 64 that provides temporary storage for program instructions and data during execution of computer applications and are read only memory (ROM) 66 often used to store program instructions required for proper operation of the device itself, as opposed to execution of computer applications. Long-term storage of programs and data is provided by high-capacity memory devices 68, such as magnetic hard drives or optical CD or DVD drives.

In a typical computer system, a considerable number of input/output devices are connected to the system bus 60 through input/output adapters 70. Commonly used input/output devices include monitors, keyboards, pointing devices and printers. Increasingly, high capacity memory devices are being connected to the system through what might be described as general-purpose input/output adapters, such as USB or FireWire adapters. Finally, the system includes one or more network adapters 72 that are used to connect the system to other computer systems through intervening computer networks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to preferred embodiments thereof, it will be apparent that modifications and variations are possible without departing from the scope of the invention defined in the appended claims.

What is claimed is:

1. A method of operating a publish/subscribe system comprising:
receiving a message from a publisher;
determining whether the received message should be retained; and,
in response to a determination that the received message should be retained, establishing a retention policy for the received message.

2. A method according to claim 1, wherein establishing a retention policy for the received message further comprises selecting an action from a set of possible actions comprising:
storing the received message;
deleting at least one message; and
assigning a future expiry time to at least one message.

3. A method according to claim 2, wherein the action of deleting at least one message comprises deleting the received message.

4. A method according to claim 2, wherein the action of deleting at least one message comprises deleting at least one previously retained message.

5. A method according to claim 2, wherein the action of assigning a future expiry time to at least one message comprises assigning a future expiry time to the received message.

6. A method according to claim 1 wherein determining whether the received message should be retained further comprises analyzing the content of the received message to identify any retention instructions included within the received message.

7. A method according to claim 1 wherein determining whether the received message should be retained further comprises:
identifying at least one topic to which the received message relates;
identifying a topic-based retention policy, stored in the publish/subscribe system, that relates to the identified topic; and
applying the identified topic-based retention policy to the received message to establish the retention policy for the received message.

8. A computer program product for operating a publish/subscribe system comprising a computer usable medium having computer usable program code embodied therewith, said computer usable program code comprising:
computer usable program code configured to receive a message from a publisher;
computer usable program code configured to determine whether the received message should be retained; and,
computer usable program code configured to, in response to a determination that the received message should be retained, establish a retention policy for the received message.

9. A computer program product according to claim 8 wherein said computer usable program code configured to establish a retention policy for the received message further comprises computer usable program code configured to select further computer usable program code from a set of possible computer usable program code comprising:
computer usable program code configured to store the received message;
computer usable program code configured to delete at least one message; and
computer usable program code configured assign a future expiry time to at least one message.

10. A computer program product according to claim 9, wherein the computer usable program code configured to delete at least one message comprises computer usable program code configured to delete the received message.

11. A computer program product according to claim 9, wherein the computer usable program code configured to delete at least one message comprises computer usable program code configured to delete at least one previously retained message.

12. A computer program product according to claim 9 wherein said computer usable program code configured to assign a future expiry time to at least one message further comprises computer usable program code configured to assign a future expiry time to the received message.

13. A computer program product according to claim 8 wherein said computer usable program code configured to determine whether the received message should be retained further comprises computer usable program code configured to analyze the content of the received message to identify any retention instructions included within the received message.

14. A computer program product according to claim 8 wherein said computer usable program code configured to determine whether the received message should be retained further comprises:
computer usable program code configured to identify at least one topic to which the received message relates;
computer usable program code configured to identify a topic-based retention policy, stored in the publish/subscribe system, that relates to the identified topic; and
computer usable program code configured to apply the identified topic-based retention policy to the received message to establish the retention policy for the received message.

15. A message broker for a publish/subscribe system, comprising:
means for receiving a message from a publisher;
means for determining whether the received message should be retained;
means responsive to a determination that the received message should be retained for establishing a retention policy for the received message.

16. A message broker according to claim 15 wherein said means for establishing a retention policy for the received message further comprises:
means for storing the received message;
means for deleting at least one message;
means for assigning a future expiry time to at least one message.

17. A message broker according to claim 16 wherein said means for deleting at least one message comprises means for deleting the received message.

18. A message broker according to claim 16 wherein said means for deleting at least one message comprises means for deleting at least one previously retained message.

19. A message broker according to claim 16 wherein said means for assigning a future expiry time to at least one message comprises means for assigning a future expiry time to the received message.

20. A message broker according to claim 15 wherein said means for determining whether the received message should be retained further comprises means for analyzing the content of the received message to identify any retention instructions included within the received message.

21. A message broker according to claim 15 wherein said means for determining whether the message should be retained further comprises:
means for identifying at least one topic to which the received message relates;
means for identifying a topic-based retention policy, stored in the publish/subscribe system, that relates to the identified topic; and
means for applying the identified topic-based retention policy to the received message to establish the retention policy for the received message.
